(19) United States
(12) Patent Application Publication
(10) Pub. No.: US 2024/0086787 A1
(43) Pub. Date: Mar. 14, 2024

(54) METHOD AND SYSTEM TO PREDICT NETWORK PERFORMANCE USING A HYBRID MODEL INCORPORATING MULTIPLE SUB-MODELS

(71) Applicant: Telefonaktiebolaget LM Ericsson (publ), Stockholm (SE)

(72) Inventors: Jenny YANG, Sunnyvale, CA (US); Simone VINCENZI, Santa Cruz, CA (US); Prasad JOGALEKAR, San Jose, CA (US)

(73) Assignee: Telefonaktiebolaget LM Ericsson (publ), Stockholm (SE)

(21) Appl. No.: 18/272,896

(22) PCT Filed: Jan. 19, 2021
(86) PCT No.: PCT/IB2021/050390

§ 371 Date: Jul. 18, 2023

(51) Int. Cl. G06Q 10/04; H04L 41/14; H04L 41/147; H04L 43/08

(52) U.S. Cl. CPC G06Q 10/04; H04L 41/145; H04L 41/147; H04L 43/08

(57) ABSTRACT

Methods and systems to predict network performance of a network are disclosed. In one embodiment, a method comprises: training a first sub-model using a subset of a plurality of time series of data values, where the first sub-model comprises a type of generalized additive model, and where training the first sub-model comprises determining parameters within a plurality of univariate functions of the first sub-model; and training a second sub-model using the subset of the time series of data values, wherein the second sub-model comprises a type of autoregressive integrated moving average (ARIMA) model. The method further comprises determining a weight distribution between the first and second sub-models using additional data values from the time series of data values to generate a hybrid model incorporating the first and second sub-models, and predicting a data value of the performance indicator of the network at a later day using the hybrid model.

### TECHNICAL FIELD

Embodiments of the present disclosure relate to the field of networking, and more specifically, relate to methods and systems to predict network performance of a network.

### BACKGROUND ART

Telecommunication network operators predict the performance of their networks to identify, anticipate, and ameliorate degradation of services, and present and set quality targets. Different statistical and machine learning models have been developed to analyze existing performance data to predict future network performance. For example, a network operator may collect historical performance data as a time series of performance data and use models such as an autoregressive moving average model to predict future observations.

Yet statistical or machine learning models, commercial or freely available, developed for general business use-cases are not tailored to the characteristics of telecommunication networks, whose performance, in additional to having a seasonal behavior, also can change suddenly due to changes in technology or spatial configuration of the network. For example, one model may accurately predict the volume of money transactions over banks, where the volume is expected to be smaller over the weekend than during the weekdays. Another model may accurately predict the volume of retail sales, where the volume of sales is expected to be significantly higher over major holidays than during other times of the year. In both cases, human behaviors do not change substantially year over year, so a model may use historical data from multiple years and make good prediction of the volume of money transactions or retail sales. Telecommunication networks, on the other hand, may experience substantial technological advance over, say, a year. After technology changes or changes in the spatial configuration of the network, modeling the network performance using historical data has been found not to provide accurate predictions. Thus, training a machine learning model needs to use training data with shorter duration than that necessary for training typical time series models. Additionally, network performance changes along multiple periodicities; for example, it tends to be substantially different between weekdays and weekends and to vary pronouncedly between seasons. It can also present sudden degradation that manifests as spikes and dips in the time series of network performance. Thus, it is preferable and often needed to build specific models to predict network performance of telecommunication networks.

### SUMMARY

Embodiments of the invention offer efficient ways to predict network performance of a network. In one embodiment, a method comprises training a first sub-model using a subset of a plurality of time series of data values based on a set of periodicities of the time series of data values, each of the time series comprising a series of data values indexed in day order and corresponding to a performance indicator of the network, wherein the first sub-model comprises a type of generalized additive model, and wherein training the first sub-model comprises determining parameters within a plurality of univariate functions of the first sub-model. The method further comprises training a second sub-model using the subset of the time series of data values, wherein the second sub-model comprises a type of autoregressive integrated moving average (ARIMA) model. The method also comprises determining a weight distribution between the first sub-model and second sub-model using additional data values from the time series of data values to generate a hybrid model incorporating the first and second sub-models, and predicting a data value of the performance indicator of the network at a later day using the hybrid model.

Embodiments of the invention include electronic devices to predict network performance of a network. In one embodiment, an electronic device comprises a processor and non-transitory machine-readable storage medium that provides instructions that, when executed by the processor, cause the electronic device to perform a method. The method comprises training a first sub-model using a subset of a plurality of time series of data values based on a set of periodicities of the time series of data values, each of the time series comprising a series of data values indexed in day order and corresponding to a performance indicator of the network, wherein the first sub-model comprises a type of generalized additive model, and wherein training the first sub-model comprises determining parameters within a plurality of univariate functions of the first sub-model. The method further comprises training a second sub-model using the subset of the time series of data values, wherein the second sub-model comprises a type of autoregressive integrated moving average (ARIMA) model. The method also comprises determining a weight distribution between the first sub-model and second sub-model using additional data values from the time series of data values to generate a hybrid model incorporating the first and second sub-models, and predicting a data value of the performance indicator of the network at a later day using the hybrid model.

Embodiments of the invention include non-transitory machine-readable storage media that provide instructions (e.g., computer program) that, when executed by a processor of an electronic device, cause the electronic device to perform operations comprising one or more methods of the embodiments of the invention.

Through embodiments of the invention, an operator/agent of a network may predict network performance of a network. The operator/agent may then implement remedial measures on the network nodes/cells to improve the network performance.

### BRIEF DESCRIPTION OF THE DRAWINGS

The invention may best be understood by referring to the following description and accompanying drawings that illustrate embodiments of the invention.

FIG. 1 shows operations to predict network performance using a hybrid model per some embodiments.

FIG. 2 shows the training of a generalized additive model (GAM) as a sub-model per some embodiments.

FIG. 3 shows the training of an ARIMA model as a sub-model per some embodiments.

FIG. 4 shows the training of a hybrid model to predict network performance data per some embodiments.

FIG. 5 is a flow diagram showing the operations to predict network performance per some embodiments.

FIG. 6 is a flow diagram showing the operations to pre-process network performance data per some embodiments.

FIG. 7 shows an electronic device implementing the classification of network nodes/cells based on performance seasonality per some embodiments.

FIG. 8 shows a wireless network per some embodiments.

FIG. 9 shows a virtualization environment per some embodiments.

FIG. 10 shows a telecommunication network connected via an intermediate network to a host computer per some embodiments.

### DETAILED DESCRIPTION

The following description describes methods, apparatus, and computer programs to predict network performance of a network. In the following description, numerous specific details such as logic implementations, opcodes, means to specify operands, resource partitioning/sharing/duplication implementations, types and interrelationships of system components, and logic partitioning/integration choices are set forth to provide a more thorough understanding of the present invention. One skilled in the art will appreciate, however, that the invention may be practiced without such specific details. In other instances, control structures and full software instruction sequences have not been shown in detail in order not to obscure the invention. Those of ordinary skill in the art, with the included descriptions, will be able to implement proper functionality without undue experimentation.

Bracketed text and blocks with dashed borders (such as large dashes, small dashes, dot-dash, and dots) may be used to illustrate optional operations that add additional features to the embodiments of the invention. Such notation, however, should not be taken to mean that these are the only options or optional operations, and/or that blocks with solid borders are not optional in some embodiments of the invention.

Network Performance Data and Modeling

The performance of a network may be measured by a set of performance indicators, referred to as key performance indicators (KPIs). Different network operators may use different sets of KPIs as the indicator of their network performance. The KPIs may be measured from the network node side or the wireless device side of the network (or by another electronic device operated by a network operator) and may indicate the performance of a network node and/or cell.

For example, a set of KPIs to measure the performance of a network may include one or more of a dropped-call rate (DCR), a network throughput, a traffic latency, a packet loss rate, a retransmission rate, a reference signal received power (RSRP) level measured by a wireless device in the network, a number of connected wireless devices to a network node in the network, a total number of calls during a period at the network node, and network uptime measured at the network node/wireless device. The KPI data may be compared to corresponding thresholds to determine whether the network performance is acceptable. When the comparison indicates that the network performance is unacceptable, network operators may perform remedial measures to enhance network performance. Note while embodiments of the present application apply to any performance indicator of a network, dropped-call rate (DCR) is used as a non-limiting example to explain the embodiments. The DCR (or the number of dropped calls over the total number of initiated calls), measuring calls that are terminated without any of the calling parties intentionally interrupting the call, is a measure that directly affects the calling parties' experience with a network, thus is an intuitive measure of network performance.

While some network nodes have omnidirectional cells (also referred to as omnicells), others have sectorized cells, each covering one sector of a network node. A network node (or another electronic device) may collect KPI data values of its cells, and the time series of data values may include performance indicator data values of the cells of network nodes as well. The embodiments of the present application apply to both network nodes and cells, even though network nodes are used as non-limiting examples to explain the embodiments.

With the ability to analyze data without using explicit instructions, machine learning and artificial intelligence (AI) provide good solutions to address this complex issue, as machine learning and AI rely on pattern recognition and inference to analyze large sets of data. A machine learning model may be built to analyze time series of performance data (also referred to as KPI data values or performance data values, and these terms are used interchangeably herein) and predict the performance data in a future date.

A number of machine learning models may be used to predict network performance. Many models are variations or extensions of the autoregressive moving average (ARMA) model, which models the time series based on its own past values (its own lags and the lagged forecast errors) and uses the derived time-series equation to predict future values. For example, such models include autoregressive integrated moving average (ARIMA), seasonal ARIMA (SARIMA), autoregressive conditional heteroscedasticity (ARCH), and generalized ARCH (GARCH) models.

Additionally, auto-correlation function (ACF) and partial auto-correlation function (PACF) have been used to identify seasonality and trend by removing the series dependence on time (i.e., differencing) or seasonality decomposition. The results of the ACF and PACF are then used to fine-tune other model parameters. The process, however, is labor intensive and it is challenging to properly tune the parameters of the ACF and PACF.

There are also “AutoML” wrappers created for these models such as Auto-ARIMA, which can tune automatically (i.e., without the user intervention) the parameters of the model. These wrappers are computationally expensive to implement. A recently developed, popular approach for time series modeling when large data sets (e.g., hundreds of thousands of records) for model training are available is the use of Long short-term memory (LSTM) recurrent neural networks. Yet, empirical experiments and studies have found that models such as LSTM predict network performance poorly when only small to middle-size data sets (e.g., thousands of data points) are available to train a machine learning model.

As discussed in the background, telecommunication networks have characteristics that make training a machine learning model challenging, e.g., it requires training time series of performance data with multiple periodicities over a shorter time span, and existing models do not appear to offer good solutions for describing and/or predicting network performance well.

### Predict Network Performance Using Hybrid Model

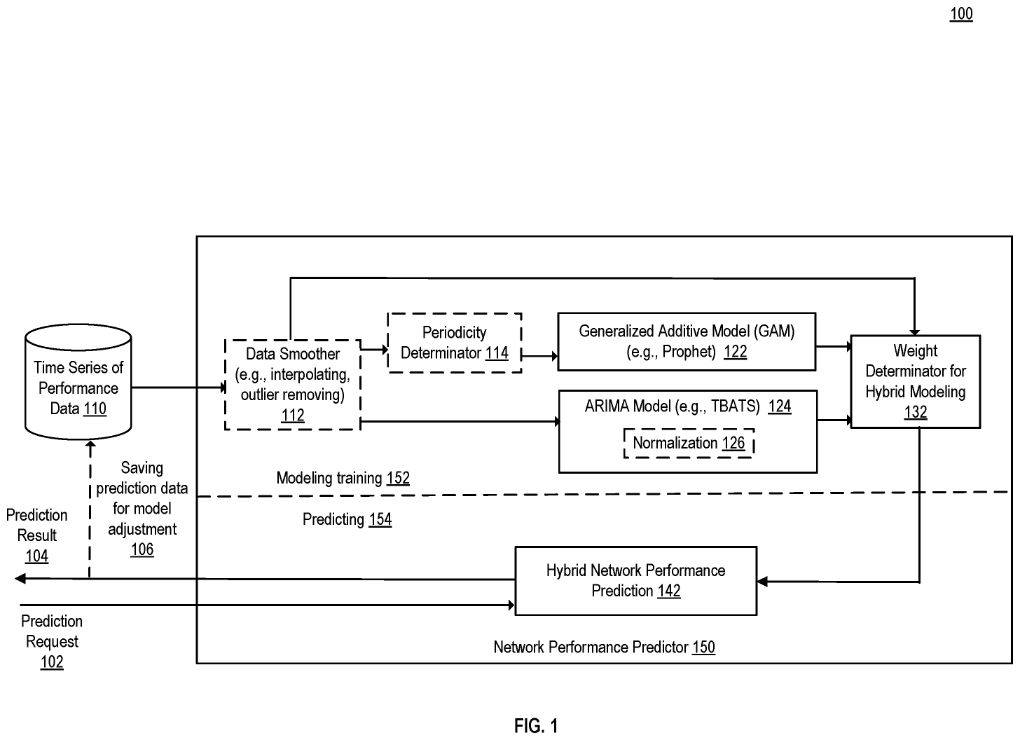

FIG. 1 shows operations to predict network performance using a hybrid model per some embodiments. FIG. 1 shows time series of performance data 110, which is stored in a database, and it is fed into a network performance predictor 150. The time series of performance data 110 may comprise multiple time series of data values corresponding to a performance indicator of network nodes within a network. For example, a time series of performance data values may be daily DCRs of a network node for 15 months. The daily data may be derived from multiple measurements throughout a day at the network node, e.g., it may be the average, median, maximum, or minimum (or results of other arithmetic operations) of the multiple daily measurements.

The network performance predictor 150 operates in two phases to perform prediction. One is the modeling training phase 152, and the other is a predicting phase 154. In the modeling training phase 152, the network performance predictor 150 may remove “noises” in the time series of performance data 110 through a data smoother 112.

The data smoother 112 may include an interpolator to add missing data value(s) in a time series. For example, if the incoming time series includes dropped-call rates (DCRs) at 0.095%, 0.07%, 0.09%, 0.095%, 0.10%, and 0.11%, 0.1 at days 1, 2, 4, 5, 6, and 7, the interpolator may add a data point 0.08% for day 3 in the time series so the time series has a full set of data of a week.

The data smoother 112 may also include a filter to filter out high-frequency components in a time series, i.e., data that changes too rapidly (e.g., over a cut-off frequency) in the time series. In one embodiment, a Savitzky-Golay smoothing filter, also known as least squares or digital smoothing polynomial (DISPO) filter, is selected as the main low-pass filter with a duration (e.g., 61 days) as its window size. Additionally or alternatively, embodiments may use the three-sigma rule to remove sudden spikes and dips in the time series of performance data. The three-sigma rule removes data that are more than three standard deviations away from the mean value of the data values over the whole time series.

The time series of performance data, after optionally being processed by the data smoother 112, may be provided to a periodicity determinator 114 to determine one or more periodicities of each time series. The processed performance data is then used to train a first sub-model, a generalized additive model (GAM) 122. Additionally, the time series of performance data 110, optionally being processed through the data smoother 112 first, is used to train a second sub-model, an ARIMA model 124.

Both sub-models are trained so that parameter values are assigned to each of the sub-models. The training of a sub-model is to adjust the parameter values of the sub-model so that the predicted network performance data from the sub-model is a good estimate of the known network performance data (which is also in the time series of performance data 110 and may be referred to as ground truth data). The training of sub-models will be discussed in more details herein below.

Then additional data from the time series of performance data 110 (optionally being processed by the data smoother 112 first) is fed to a weight determinator for hybrid modeling 132 so that a hybrid model may adjust a first weight applied to a prediction from the GAM sub-model 122 and a second weight applied to a prediction from the ARIMA sub-model 124, respectively. The training of the weight determinator 132 is to adjust the weights so that the hybrid model provides a good estimate of the known network performance data, similar to the training of the sub-models. The difference is that the training here may be a different subset from the time series of performance data (one that is not used for training the sub-models), and the training is to adjust the weights without adjusting the parameter values of the sub-models.

Once the network performance predictor 150 completes its training, it may enter the predicting phase 154, when a hybrid network performance prediction module 142 predicts network performance regarding the network performance indicator at a future time responsive to a prediction request 102. The prediction result 104 may also be saved in the database as historical predicted performance data to compare with the later observed network performance data (ground truth data) when the future time arrives, so that the comparison may be used to further train the hybrid model.

As shown, the embodiments use the two sub-models to individually predict network performance of a network node, and then weight their predictions on the same network node to derive an integrated prediction (also referred to as ensemble prediction). The two sub-models fit the time series of performance data with different mathematical formulations, and experiments have shown that they tend to have different, and often complementary, biases. When two or more sub-models that try to describe the same process have complementary biases (e.g., one sub-model tends to under-predict and another tends to over-predict), combining them in a single, ensemble (or hybrid) model can provide predictions that are less biased overall and thus more accurate than those of the single sub-models individually. Note that under-predict and over-predict are also referred to as overfit and underfit, respectively. While only two sub-models are shown in FIG. 1, additional sub-models may be added in the network performance predictor 150, in which case the weight determinator 132 may determine three or more weights, each weight for a respective sub-model.

Using the network performance predictor 150, a network operator may use time series of performance data in a periodicity, and also predict future network performance in the same periodicity far ahead of time and act proactively to improve network performance. For example, one may train the network performance predictor 150 using daily DCRs data of multiple network nodes in an area in the past 30 months, and then the trained hybrid model may predict the daily DCRs of a network node in the area a month or even a quarter ahead of time.

The prediction using the hybrid model allows the network operator to identify the network nodes/cells that may have degraded performance ahead of time. It is known that some network nodes/cells experience seasonal performance degradation such as higher DCRs during summer/winter months, and the network operator may mitigate the upcoming performance degradation. For example, the network operator may increase the power level of a degrading network node during the period that it tends to have deteriorated performance, change the direction of the antenna of the network node during the period, reconfigure existing cells or add more cells so that the area covered by potentially degrading cells may not suffer deterioration when the predicted seasonal degradation time comes, and/or add additional network nodes (e.g., temporarily for weeks/months/seasons) to share the workload so the network performance is improved.

Train Generalized Additive Model (GAM) as a Sub-Model within a Hybrid Model

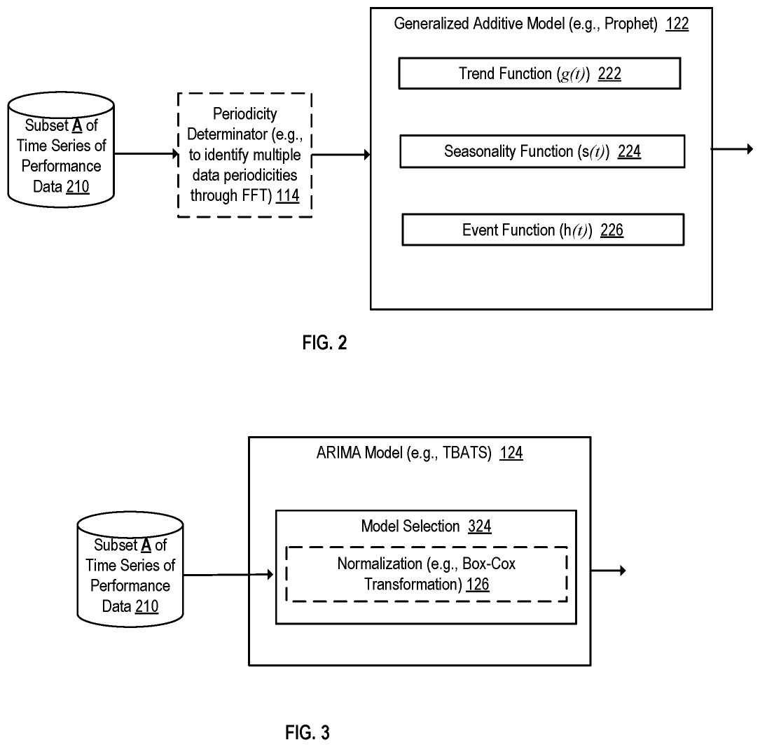

FIG. 2 shows the training of a generalized additive model (GAM) as a sub-model per some embodiments. The training uses a subset A of the time series of performance data, and the subset A is shown at reference 210. The subset A may be a subset of the time series of performance data 110.

The subset A of the time series of performance data 210 may be optionally provided to the periodicity determinator 114. While a Generalized Additive Model (GAM) generally has a default periodicity to run the training, the time series of performance data of a network node/cell may have multiple periodicities that affect the performance of the network node/cell significantly. For example, a network node/cell may experience seasonal performance degradation over a few months of a year (e.g., summer/winter months), weekly performance degradation over a few weeks of the year (e.g., the Christmas and New Year week(s) in the US), in addition to daily degradation over specific days of the year. By identifying multiple periodicities, the embodiments may train the GAM model to fit the ground truth performance data closer.

In some embodiments, the periodicity determinator uses a Fast Fourier Transform (FFT) to derive the frequency domain representation of a time series and identify the multiple frequency components, which correspond to multiple periodicities of the time series. The determined multiple periodicities may then be fed to the GAM 122, along with the subset of time series of performance data.

While the GAM model class includes both multivariate and univariate GAMs, embodiments of the invention use the type of univariate GAM (time being the variable). In some embodiments, the GAM 122 comprises Prophet, an open-source time series forecast procedure, to which identified one or more periodicities are provided so that Prophet may use the derived periodicities in addition to its default periodicity (or periodicities).

A generalized additive model (GAM) is a generalized linear model in which the linear response variable depends linearly on unknown smooth functions of some predictor variables. For the time series of performance data, the additive model uses a decomposable time series model with three main model components: a trend function g(t) 222, a seasonality function s(t) 224, and an event function h(t) 226 in some embodiments. The model can be expressed as the following:

y(t)=g(t)+s(t)+h(t)+e(t) (1)

In formula (1), the additional element e(t) covers changes not accommodated by the model (i.e., it is the residual error), g(t) models non-periodic changes (e.g., growth/reduction over time), s(t) models periodic (e.g., weekly, monthly, yearly) changes, and h(t) models effects of holidays or special events (e.g., national holidays, school start days, local sport events) at which locale the network nodes/cells are deployed. The trend function g(t) 222 may use a saturating growth model or a piecewise linear model, the seasonality function s(t) 224 may apply Fourier series to model seasonality, and the event function h(t) 226 takes the input of local calendar to fuse the event consideration into the sub-model. Each of the functions may be a polynomial, a spline, or another linear or non-linear function described by a set of parameters.

The GAM model is trained by estimating the parameter values of trend function g(t) 222, seasonality function s(t) 224, and event function h(t) 226 so that the predicted performance data matches the ground truth performance data the best (so that e(t) is minimized). The parameters are determined/estimated based on reducing modeling error (e.g., e(t)) and complexity penalty (e.g., the higher order the polynomial of a function, the higher the complexity penalty).

The training completes when the prediction error (the difference between the predicted performance data and the ground truth performance data) drops below a certain threshold or the subset A of the time series of performance data is exhausted.

Train ARIMA Model as a Sub-Model within the Hybrid Model

FIG. 3 shows the training of an ARIMA model as a sub-model per some embodiments. The training uses the subset A of the time series of performance data, and the subset A is shown at reference 210. While FIGS. 2 and 3 show that the training of the GAM sub-model and ARIMA model uses the same subset of the time series of performance data 110, an alternative embodiment may use different subsets of the time series of performance data 110.

The ARIMA model class has numerous variations and extensions such as seasonal ARIMA (SARIMA), autoregressive conditional heteroscedasticity (ARCH), and generalized ARCH (GARCH) models. A later model in the class includes the Box-Cox transform, ARMA errors, Trend, and Seasonal Components (BATS) model, which is named after the initial of the four components. The BATS model includes arguments from the four main components: BATS(ω, φ, p, q, m₁, m₂, . . . , m_{T}), where ω represents the Box-Cox transformation parameter, φ represents the damping parameter, (p, q) represents the ARMA parameters, and (m₁, m₂, . . . , m_{T}) represents the seasonal periods. The parameter values of a BATS model may be selected so that a BATS model can represent earlier models, e.g., BATS(1, 1, 1, 0, 0, m₁, m₂) represents double seasonal Holt-Winter's additive seasonal model.

Additionally, a further variation of the ARIMA model introduces trigonometric representation of seasonal components and is called Trigonometric BATS (TBATS) model, which introduces another seasonal component k that denotes the number of harmonics required for a seasonal component m, and a TBATS model may be characterized as TBATS(ω, φ, p, q, {m₁, k₁}, {m₂, k₂}, . . . , {m_{T}, k_{T}}).

The model selection module 324 trains the model using the incoming time series of performance data. A time series of performance data may be normalized using the normalization module 126, when the time series of performance data may not follow a Gaussian distribution. The normalization may be performed through a Box-Cox transformation. The training provides proper values for each parameter of the model, i.e., when a TBATS model is trained, the value of each of the parameters ω, φ, p, q, {m₁, k₁}, {m₂, k₂}, . . . , {m_{T}, k_{T}} is determined. Note that when k is undefined, a TBATS model becomes a BATS model, and when other parameter values are determined to be certain values, the BATS model becomes a simpler model, e.g., as explained above, BATS(1, 1, 1, 0, 0, m₁, m₂) becomes double seasonal Holt-Winter's additive seasonal model. Thus, the model selection module 324 selects one of the types of ARIMA models (adjusting the parameter values) through the training using the incoming time series of performance data.

The training may use an Akaike Information Criterion (AIC) to determine parameter values of the ARIMA model in some embodiments. The AIC estimates out-of-sample prediction error and thereby relative quality of ARIMA models for a given time series of performance data. The AIC value may be calculated as the following:

AIC=2K−2 ln(\hat{L}) (2)

In Formula (2), K is the number of parameters in the models and L is the maximum value of the likelihood function of the model. When using AIC as a loss function, the objective of model training is to minimize the AIC value. The closer a prediction a set of model parameter values can achieve to the ground truth performance data, the higher is the 2 ln (\hat{L}) term, and the lower the AIC value will become, and thus more likely the set of model parameter values will be chosen. Yet the more parameters a model used to arrive at a given likelihood, the higher is the term 2K, and the higher the AIC value will become, and thus less likely the model will be chosen. Thus, using the AIC value rewards goodness of fit (high likelihood) but penalizes overfitting, where too many parameters are used in the model.

In some embodiments, the ARIMA model is trained by adjusting the parameter values of TBATS(ω, φ, p, q, {m₁, k₁}, {m₂, k₂}, . . . , {m_{T}, k_{T}}) so that the predicted performance data matches the ground truth performance data the best, and the training completes when the AIC is below a certain threshold or the subset of the time series of performance data allocated to the ARIMA is exhausted. Alternatively, the ARIMA model may be trained by adjusting values of less parameters based on the variation of the ARIMA model, e.g., BATS model with BATS(ω, φ, p, q, m₁, m₂, . . . , m_{T}) in some embodiments.

Train the Hybrid Model

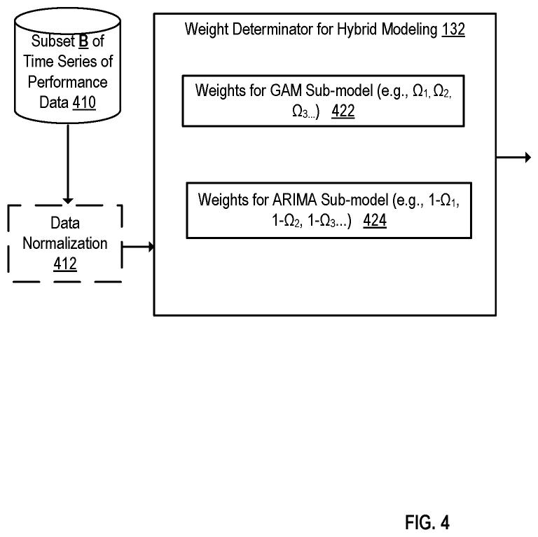

FIG. 4 shows the training of a hybrid model to predict network performance data per some embodiments. The training uses subset B of the time series of performance data. The subset B is shown at reference 410, and it may be a subset of the time series of performance data 110. The training of the hybrid model uses a subset of time series of performance data that is different from the ones used by the sub-models in some embodiments (e.g., subset A being the 80% time series of performance data 110 and subset B being the remaining 20%). Because the subset B is different from subset A used in FIGS. 2 and 3, the subset B data pass through a data normalization module 412 as well. The data normalization may be performed through a Box-Cox transformation as the one in the normalization module 126, but it may use other normalization methods such as minimum-maximum feature scaling or log-transformation.

The weight determinator for hybrid modeling 132 determines the respective contribution of the GAM sub-model and the ARIMA sub-model. It may try a set of weights and determine which applies to the hybrid model so that the predicted performance data fit the ground truth data from the subset B the best. The best weights (or regression parameters) can be found using the constraint that they must sum to value one (1) or using standard linear or non-linear regression. For example, in the case of the constraint that weights must sum to value one (1), when the GAM sub-model is assigned weight Ω₁, the ARIMA sub-model will be assigned weight 1−Ω₁, and the prediction error will be compared with the prediction error of the weight allocation (Ω₂, 1−Ω₂) between the GAM sub-model and the ARIMA sub-model. The weight pair that results in less prediction error will be saved to compare with the next pair. The training continues until a weight pair achieves prediction error below a certain threshold or the subset B of the time series of performance data is exhausted. In a different embodiment, other pairs of weights (which do not sum to be the value one) may be used to train the hybrid model. For example, the hybrid model to predict a DCR of a network node (P) may be, P=alpha+w1×f_{GAM}+w2×f_{ARIMA}, where alpha, w1, and w2 are estimated through ordinary least-squares regression.

Through the hybrid model, the prediction may take advantage of the complementary features of the two sub-models. Because the two sub-models have demonstrated complementary biases in predicting network performance data (e.g., one sub-model tends to predict values higher than ground truth data while the other sub-model tends to predict values lower, or vice versa), the hybrid model may provide predictions that are less biased overall than those of either sub-model individually. Note that while only two sub-models are used to form the hybrid models, some embodiments may use three or more sub-models, whose training can be computationally more expensive, but may achieve better prediction results.

Operations to Predict Network Performance Per Some Embodiments

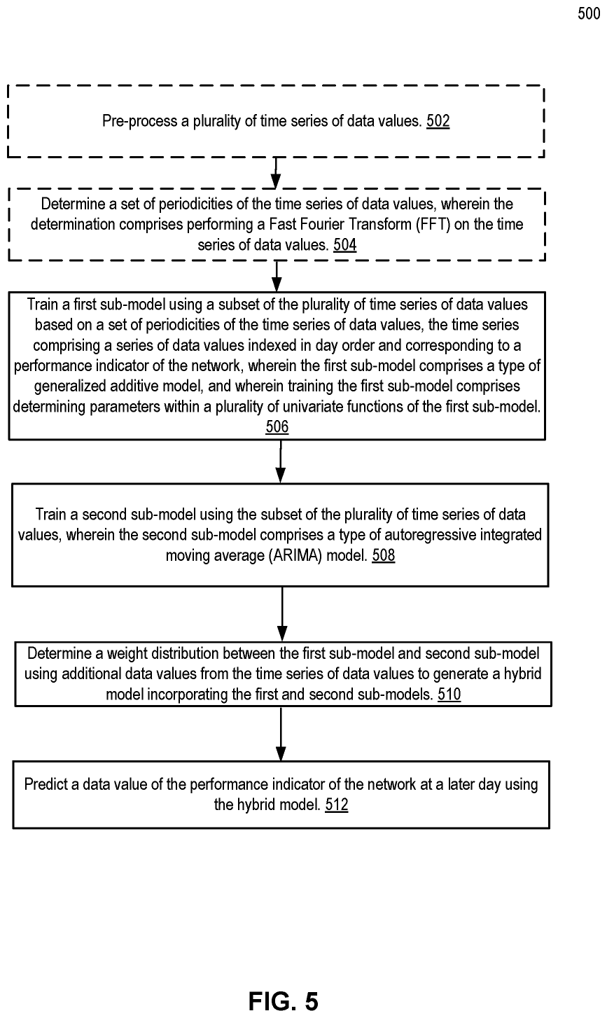

FIG. 5 is a flow diagram showing the operations to predict network performance per some embodiments. Method 500 may be performed by an electronic device in a network. The network may include network nodes and cells to provide services to wireless devices of the network.

At reference 502, a plurality of time series of data values is preprocessed. The plurality of time series of data values is the time series of performance data 110 in some embodiments. At reference 504, a set of periodicities of the time series of data values is determined, where the determination comprises performing a Fast Fourier Transform (FFT) on the time series of data values in some embodiments. The determination of the periodicities is discussed herein above relating to FIGS. 1 and 2.

At reference 506, a first sub-model is trained using a subset of a plurality of time series of data values based on a set of periodicities of the time series of data values, each of the time series comprising a series of data values indexed in day order and corresponding to a performance indicator of the network. The first sub-model comprises a type of generalized additive model, and training the first sub-model comprises determining parameters within a plurality of univariate functions of the first sub-model. The training of the first sub-model is discussed herein above relating to FIGS. 1 and 2.

At reference 508, a second sub-model is trained using the subset of the time series of data values, wherein the second sub-model comprises a type of autoregressive integrated moving average (ARIMA) model. In some embodiments, training the second sub-model comprises normalizing the subset of the time series of data values. In some embodiments, training the second sub-model comprises using the Akaike Information Criterion (AIC) to determine the best parameter values of the ARIMA model according to AIC. In some embodiments, the second sub-model comprises a Trigonometric Box-Cox transform, ARMA errors, Trend, and Seasonal components (TBATS) model. In some embodiments, training the second sub-model comprises normalizing the subset of the time series of data values using a Box-Cox transformation. The training of the second sub-model is discussed herein above relating to FIGS. 1 and 3.

At reference 510, a weight distribution between the first sub-model and second sub-model is determined using additional data values from the time series of data values to generate a hybrid model incorporating the first and second sub-models. The determination of the weight distribution is discussed herein above relating to FIGS. 1 and 4.

At reference 512, a data value of the performance indicator of the network at a later day is predicted using the hybrid model.

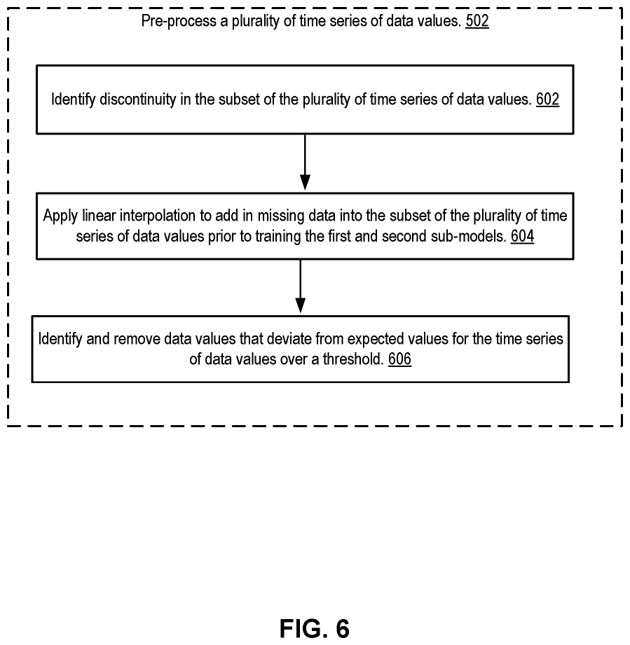

FIG. 6 is a flow diagram showing the operations to pre-process network performance data per some embodiments. In some embodiments, the operations are performed with the box of 502 of FIG. 5. At reference 602, missing data values in the subset of the plurality of time series of data values are identified, and at reference 604, linear interpolation is applied to add in one or more missing data values into the subset of the plurality of time series of data values prior to training the first and second sub-models.

At reference 606, data values that deviate from expected values for a time series of data values over a threshold are identified and removed prior to training the first and second sub-models.

In some embodiments, the performance indicator is one of the following: a call drop rate, a network throughput, a traffic latency, a packet loss rate, a retransmission rate, a reference signal received power (RSRP) level measured by a wireless device in the network, a number of connected wireless devices to a network node, a total number of calls during a period at the network node, and network uptime measured at the network node.

Terms

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein, refers to any positive whole number of items including one item.

An electronic device stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals—such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

A wireless communication network (or “wireless network,” and the two terms are used interchangeably) is a network of electronic devices communicating using radio waves (electromagnetic waves within the frequencies 30 KHz-300 GHz). The wireless communications may follow wireless communication standards, such as new radio (NR), LTE-Advanced (LTE-A), LTE, wideband code division multiple access (WCDMA), High-Speed Packet Access (HSPA). Furthermore, the communications between the electronic devices such as network devices and terminal devices in the wireless communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. While LTE and NR are used as examples to describe embodiments of the invention, the invention may apply to other wireless communication networks, including LTE operating in unlicensed spectrums, Multefire system, IEEE 802.11 systems.

A network node or node (also referred to as a network device (ND), and these terms are used interchangeably in this disclosure) is an electronic device in a wireless communication network via which a wireless device accesses the network and receives services therefrom. One type of network node may refer to a base station (BS) or an access point (AP), for example, a node B (NodeB or NB), an evolved NodeB (eNodeB or eNB), a next generation node B (gNB), a remote radio unit (RRU), a radio header (RH), a remote radio head (RRH), a relay, and a low power node such as a femtocell and a picocell.

A wireless device (WD) may access a wireless communication network and receive services from the wireless communication network through a network node. A wireless device may also be referred to as a terminal device, and the two terms are used interchangeably in this disclosure. A wireless device may be a subscriber station (SS), a portable subscriber Station, a mobile station (MS), an access terminal (AT), or other end user devices. An end user device (also referred to as end device, and the two terms are used interchangeably) may be one of a mobile phone, a cellular phone, a smart phone, a tablet, a wearable device, a personal digital assistant (PDA), a portable computer, an image capture terminal device (e.g., a digital camera), a gaming terminal device, a music storage and playback appliance, a smart appliance, a vehicle-mounted wireless terminal device, a smart speaker, and an Internet of Things (IoT) device. Terminal devices may be coupled (e.g., through customer premise equipment coupled to an access network (wired or wirelessly)) to edge NDs, which are coupled (e.g., through one or more core NDs) to other edge NDs, which are coupled to electronic devices acting as servers.

An Electronic Device Implementing Embodiments of the Invention

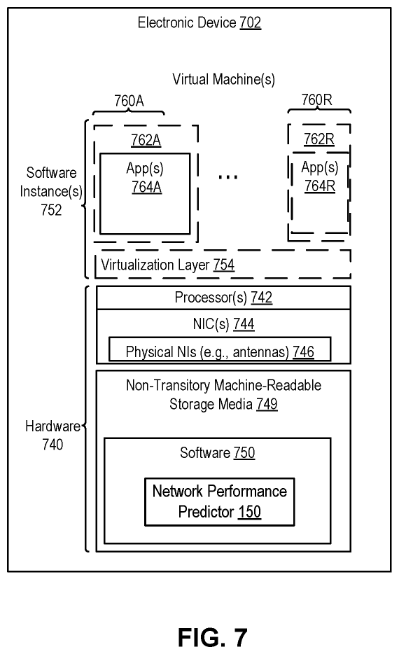

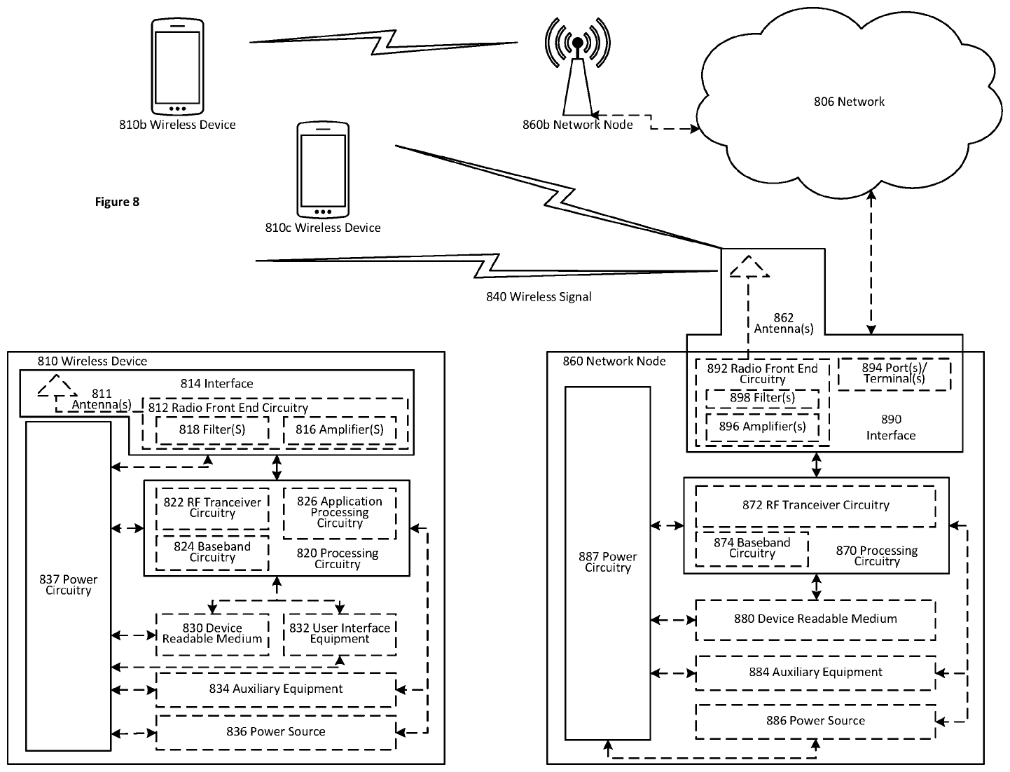

FIG. 7 shows an electronic device implementing the network performance prediction per some embodiments. The electronic device 702 may be implemented using custom application-specific integrated-circuits (ASICs) as processors and a special-purpose operating system (OS), or common off-the-shelf (COTS) processors and a standard OS.

The electronic device 702 includes hardware 740 comprising a set of one or more processors 742 (which are typically COTS processors or processor cores or ASICs) and physical NIs 746, as well as non-transitory machine-readable storage media 749 having stored therein software 750. During operation, the one or more processors 742 may execute the software 750 to instantiate one or more sets of one or more applications 764A-R. While one embodiment does not implement virtualization, alternative embodiments may use different forms of virtualization. For example, in one such alternative embodiment the virtualization layer 754 represents the kernel of an operating system (or a shim executing on a base operating system) that allows for the creation of multiple instances 762A-R called software containers that may each be used to execute one (or more) of the sets of applications 764A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 754 represents a hypervisor (sometimes referred to as a virtual machine monitor (VMM)) or a hypervisor executing on top of a host operating system, and each of the sets of applications 764A-R run on top of a guest operating system within an instance 762A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 740, directly on a hypervisor (in which case the unikernel is sometimes described as running within a LibOS virtual machine), or in a software container, embodiments can be implemented fully with unikernels running directly on a hypervisor represented by virtualization layer 754, unikernels running within software containers represented by instances 762A-R, or as a combination of unikernels and the above-described techniques (e.g., unikernels and virtual machines both run directly on a hypervisor, unikernels, and sets of applications that are run in different software containers).

The software 750 contains a network performance predictor 150 that performs operations described with reference to FIGS. 1-6. The network performance predictor 150 may be instantiated within the applications 764A-R. The instantiation of the one or more sets of one or more applications 764A-R, as well as virtualization if implemented, are collectively referred to as software instance(s) 752. Each set of applications 764A-R, corresponding virtualization construct (e.g., instance 762A-R) if implemented, and that part of the hardware 740 that executes them (be it hardware dedicated to that execution and/or time slices of hardware temporally shared), forms a separate virtual electronic device 760A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). An NI (physical or virtual) may be numbered (an NI with an IP address) or unnumbered (an NI without an IP address).

A Wireless Network in Accordance with Some Embodiments

Although the subject matter described herein may be implemented in any appropriate type of system using any suitable components, the embodiments disclosed herein are described in relation to a wireless network, such as the example wireless network illustrated in FIG. 8. For simplicity, the wireless network of FIG. 8 only depicts network 806, network nodes 861 and 860b, and WDs 810, 810b, and 810c. In practice, a wireless network may further include any additional elements suitable to support communication between wireless devices or between a wireless device and another communication device, such as a landline telephone, a service provider, or any other network node or end device. Of the illustrated components, network node 860 and wireless device (WD) 810 are depicted with additional detail. The wireless network may provide communication and other types of services to one or more wireless devices to facilitate the wireless devices' access to and/or use of the services provided by, or via, the wireless network. In one embodiment, one or more of the network nodes 861 and 860b, WDs 810, 810b, and 810c are installed in fixed location; thus, the wireless network operates as a fixed wireless network.

The wireless network 806 may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave, and/or ZigBee standards.

Network 806 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 860 and WD 810 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

Network node 860 and WD 810 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node, similar to network device discussed herein above, refers to equipment capable, configured, arranged, and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs), and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay.

A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node 860 includes processing circuitry 870, device readable medium 880, interface 890, auxiliary equipment 884, power source 886, power circuitry 887, and antenna 862. Although network node 860 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions, and methods disclosed herein. Moreover, while the components of network node 860 are depicted as single boxes located within a larger box, or nested within multiple boxes, in practice, a network node may comprise multiple different physical components that make up a single illustrated component (e.g., device readable medium 880 may comprise multiple separate hard drives as well as multiple RAM modules).

Similarly, network node 860 may be composed of multiple physically separate components (e.g., a NodeB component and an RNC component, or a BTS component and a BSC component, etc.), which may each have their own respective components. In certain scenarios in which network node 860 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 860 may be configured to support multiple radio access technologies (RATs). In such embodiments, some components may be duplicated (e.g., separate device readable medium 880 for the different RATs) and some components may be reused (e.g., the same antenna 862 may be shared by the RATs). Network node 860 may also include multiple sets of the various illustrated components for different wireless technologies integrated into network node 860, such as, for example, GSM, WCDMA, LTE, NR, WiFi, or Bluetooth wireless technologies. These wireless technologies may be integrated into the same or different chip or set of chips and other components within network node 860.

Processing circuitry 870 is configured to perform any determining, calculating, or similar operations (e.g., certain obtaining operations) described herein as being provided by a network node. These operations performed by processing circuitry 870 may include processing information obtained by processing circuitry 870 by, for example, converting the obtained information into other information, comparing the obtained information or converted information to information stored in the network node, and/or performing one or more operations based on the obtained information or converted information, and as a result of said processing making a determination.

Processing circuitry 870 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other network node 860 components, such as device readable medium 880, network node 860 functionality. For example, processing circuitry 870 may execute instructions stored in device readable medium 880 or in memory within processing circuitry 870. Such functionality may include providing any of the various wireless features, functions, or benefits discussed herein. In some embodiments, processing circuitry 870 may include a system on a chip (SoC).

In some embodiments, processing circuitry 870 may include one or more of radio frequency (RF) transceiver circuitry 872 and baseband processing circuitry 874. In some embodiments, radio frequency (RF) transceiver circuitry 872 and baseband processing circuitry 874 may be on separate chips (or sets of chips), boards, or units, such as radio units and digital units. In alternative embodiments, part or all of RF transceiver circuitry 872 and baseband processing circuitry 874 may be on the same chip or set of chips, boards, or units.

In certain embodiments, some or all of the functionality described herein as being provided by a network node, base station, eNB, or other such network device may be performed by processing circuitry 870 executing instructions stored on device readable medium 880 or memory within processing circuitry 870. In alternative embodiments, some or all of the functionality may be provided by processing circuitry 870 without executing instructions stored on a separate or discrete device readable medium, such as in a hard-wired manner. In any of those embodiments, whether executing instructions stored on a device readable storage medium or not, processing circuitry 870 can be configured to perform the described functionality. The benefits provided by such functionality are not limited to processing circuitry 870 alone or to other components of network node 860, but are enjoyed by network node 860 as a whole, and/or by end users and the wireless network generally.

Device readable medium 880 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 870. Device readable medium 880 may store any suitable instructions, data, or information, including a computer program, software, an application including one or more of logic, rules, code, tables, etc., and/or other instructions capable of being executed by processing circuitry 870 and, utilized by network node 860. Device readable medium 880 may be used to store any calculations made by processing circuitry 870 and/or any data received via interface 890. In some embodiments, processing circuitry 870 and device readable medium 880 may be considered to be integrated. In some embodiments, the device readable medium 980 may comprise the network performance predicator 150.

Interface 890 is used in the wired or wireless communication of signaling and/or data between network node 860, network 806, and/or WDs 810. As illustrated, interface 890 comprises port(s)/terminal(s) 894 to send and receive data, for example to and from network 806 over a wired connection. Interface 890 also includes radio front end circuitry 892 that may be coupled to, or in certain embodiments a part of, antenna 862. Radio front end circuitry 892 comprises filters 898 and amplifiers 896. Radio front end circuitry 892 may be connected to antenna 862 and processing circuitry 870. Radio front end circuitry may be configured to condition signals communicated between antenna 862 and processing circuitry 870. Radio front end circuitry 892 may receive digital data that is to be sent out to other network nodes or WDs via a wireless connection. Radio front end circuitry 892 may convert the digital data into a radio signal having the appropriate channel and bandwidth parameters using a combination of filters 898 and/or amplifiers 896. The radio signal may then be transmitted via antenna 862. Similarly, when receiving data, antenna 862 may collect radio signals which are then converted into digital data by radio front end circuitry 892. The digital data may be passed to processing circuitry 870. In other embodiments, the interface may comprise different components and/or different combinations of components.

In certain alternative embodiments, network node 860 may not include separate radio front end circuitry 892, instead, processing circuitry 870 may comprise radio front end circuitry and may be connected to antenna 862 without separate radio front end circuitry 892. Similarly, in some embodiments, all or some of RF transceiver circuitry 872 may be considered a part of interface 890. In still other embodiments, interface 890 may include one or more ports or terminals 894, radio front end circuitry 892, and RF transceiver circuitry 872 as part of a radio unit (not shown), and interface 890 may communicate with baseband processing circuitry 874, which is part of a digital unit (not shown).

Antenna 862 may include one or more antennas, or antenna arrays, configured to send and/or receive wireless signals. Antenna 862 may be coupled to radio front end circuitry 892 and may be any type of antenna capable of transmitting and receiving data and/or signals wirelessly. In some embodiments, antenna 862 may comprise one or more omni-directional, sector, or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 862 may be separate from network node 860 and may be connectable to network node 860 through an interface or port.

Antenna 862, interface 890, and/or processing circuitry 870 may be configured to perform any receiving operations and/or certain obtaining operations described herein as being performed by a network node. Any information, data, and/or signals may be received from a wireless device, another network node, and/or any other network equipment. Similarly, antenna 862, interface 890, and/or processing circuitry 870 may be configured to perform any transmitting operations described herein as being performed by a network node. Any information, data, and/or signals may be transmitted to a wireless device, another network node, and/or any other network equipment.

Power circuitry 887 may comprise, or be coupled to, power management circuitry and is configured to supply the components of network node 860 with power for performing the functionality described herein. Power circuitry 887 may receive power from power source 886. Power source 886 and/or power circuitry 887 may be configured to provide power to the various components of network node 860 in a form suitable for the respective components (e.g., at a voltage and current level needed for each respective component). Power source 686 may either be included in, or external to, power circuitry 887 and/or network node 860. For example, network node 860 may be connectable to an external power source (e.g., an electricity outlet) via an input circuitry or interface such as an electrical cable, whereby the external power source supplies power to power circuitry 887. As a further example, power source 886 may comprise a source of power in the form of a battery or battery pack which is connected to, or integrated in, power circuitry 887. The battery may provide backup power should the external power source fail. Other types of power sources, such as photovoltaic devices, may also be used.

Alternative embodiments of network node 860 may include additional components beyond those shown in FIG. 8 that may be responsible for providing certain aspects of the network node's functionality, including any of the functionality described herein and/or any functionality necessary to support the subject matter described herein. For example, network node 860 may include user interface equipment to allow input of information into network node 860 and to allow output of information from network node 860. This may allow a user to perform diagnostic, maintenance, repair, and other administrative functions for network node 860.

As used herein, wireless device (WD) refers to a device capable, configured, arranged, and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.), personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 810 includes antenna 811, interface 814, processing circuitry 820, device readable medium 830, user interface equipment 832, auxiliary equipment 834, power source 836, and power circuitry 837. WD 810 may include multiple sets of one or more of the illustrated components for different wireless technologies supported by WD 810, such as, for example, GSM, WCDMA, LTE, NR, WiFi, WiMAX, or Bluetooth wireless technologies, just to mention a few. These wireless technologies may be integrated into the same or different chips or set of chips as other components within WD 810.

Antenna 811 may include one or more antennas or antenna arrays, configured to send and/or receive wireless signals, and is connected to interface 814. In certain alternative embodiments, antenna 811 may be separate from WD 810 and be connectable to WD 810 through an interface or port. Antenna 811, interface 814, and/or processing circuitry 620 may be configured to perform any receiving or transmitting operations described herein as being performed by a WD. Any information, data, and/or signals may be received from a network node and/or another WD. In some embodiments, radio front end circuitry and/or antenna 811 may be considered an interface.

As illustrated, interface 814 comprises radio front end circuitry 812 and antenna 811. Radio front end circuitry 812 comprises one or more filters 818 and amplifiers 816. Radio front end circuitry 812 is connected to antenna 811 and processing circuitry 820 and is configured to condition signals communicated between antenna 811 and processing circuitry 620. Radio front end circuitry 812 may be coupled to or a part of antenna 811. In some embodiments, WD 810 may not include separate radio front end circuitry 812; rather, processing circuitry 820 may comprise radio front end circuitry and may be connected to antenna 811. Similarly, in some embodiments, some or all of RF transceiver circuitry 822 may be considered a part of interface 814. Radio front end circuitry 812 may receive digital data that is to be sent out to other network nodes or WDs via a wireless connection. Radio front end circuitry 812 may convert the digital data into a radio signal having the appropriate channel and bandwidth parameters using a combination of filters 818 and/or amplifiers 816. The radio signal may then be transmitted via antenna 811. Similarly, when receiving data, antenna 811 may collect radio signals which are then converted into digital data by radio front end circuitry 812. The digital data may be passed to processing circuitry 820. In other embodiments, the interface may comprise different components and/or different combinations of components.

Processing circuitry 820 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with, other WD 810 components such as device readable medium 830, WD 810 functionality. Such functionality may include providing any of the various wireless features or benefits discussed herein. For example, processing circuitry 820 may execute instructions stored in device readable medium 830 or in memory within processing circuitry 820 to provide the functionality disclosed herein.

As illustrated, processing circuitry 820 includes one or more of RF transceiver circuitry 822, baseband processing circuitry 824, and application processing circuitry 826. In other embodiments, the processing circuitry may comprise different components and/or different combinations of components. In certain embodiments, processing circuitry 820 of WD 810 may comprise a SoC. In some embodiments, RF transceiver circuitry 822, baseband processing circuitry 824, and application processing circuitry 826 may be on separate chips or sets of chips. In alternative embodiments, part or all of baseband processing circuitry 824 and application processing circuitry 826 may be combined into one chip or set of chips, and RF transceiver circuitry 822 may be on a separate chip or set of chips. In still alternative embodiments, part or all of RF transceiver circuitry 822 and baseband processing circuitry 824 may be on the same chip or set of chips, and application processing circuitry 826 may be on a separate chip or set of chips. In yet other alternative embodiments, part or all of RF transceiver circuitry 822, baseband processing circuitry 824, and application processing circuitry 826 may be combined in the same chip or set of chips. In some embodiments, RF transceiver circuitry 822 may be a part of interface 814. RF transceiver circuitry 822 may condition RF signals for processing circuitry 820.

In certain embodiments, some or all of the functionality described herein as being performed by a WD may be provided by processing circuitry 820 executing instructions stored on device readable medium 830, which in certain embodiments may be a computer-readable storage medium. In alternative embodiments, some or all of the functionality may be provided by processing circuitry 820 without executing instructions stored on a separate or discrete device readable storage medium, such as in a hard-wired manner. In any of those particular embodiments, whether executing instructions stored on a device readable storage medium or not, processing circuitry 820 can be configured to perform the described functionality. The benefits provided by such functionality are not limited to processing circuitry 820 alone or to other components of WD 810, but are enjoyed by WD 810 as a whole, and/or by end users and the wireless network generally.

Processing circuitry 820 may be configured to perform any determining, calculating, or similar operations (e.g., certain obtaining operations) described herein as being performed by a WD. These operations, as performed by processing circuitry 820, may include processing information obtained by processing circuitry 820 by, for example, converting the obtained information into other information, comparing the obtained information or converted information to information stored by WD 810, and/or performing one or more operations based on the obtained information or converted information, and as a result of said processing making a determination.

Device readable medium 830 may be operable to store a computer program, software, an application including one or more of logic, rules, code, tables, etc., and/or other instructions capable of being executed by processing circuitry 820. Device readable medium 830 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 820. In some embodiments, processing circuitry 820 and device readable medium 830 may be considered to be integrated.

User interface equipment 832 may provide components that allow for a human user to interact with WD 810. Such interaction may be of many forms, such as visual, audial, tactile, etc. User interface equipment 832 may be operable to produce output to the user and to allow the user to provide input to WD 810. The type of interaction may vary depending on the type of user interface equipment 832 installed in WD 810. For example, if WD 810 is a smart phone, the interaction may be via a touch screen; if WD 810 is a smart meter, the interaction may be through a screen that provides usage (e.g., the number of gallons used) or a speaker that provides an audible alert (e.g., if smoke is detected). User interface equipment 832 may include input interfaces, devices, and circuits, and output interfaces, devices, and circuits. User interface equipment 832 is configured to allow input of information into WD 810 and is connected to processing circuitry 820 to allow processing circuitry 820 to process the input information. User interface equipment 832 may include, for example, a microphone, a proximity or other sensor, keys/buttons, a touch display, one or more cameras, a USB port, or other input circuitry. User interface equipment 832 is also configured to allow output of information from WD 810, and to allow processing circuitry 820 to output information from WD 810. User interface equipment 832 may include, for example, a speaker, a display, vibrating circuitry, a USB port, a headphone interface, or other output circuitry. Using one or more input and output interfaces, devices, and circuits, of user interface equipment 832, WD 810 may communicate with end users and/or the wireless network, and allow them to benefit from the functionality described herein.

Auxiliary equipment 834 is operable to provide more specific functionality which may not be generally performed by WDs. This may comprise specialized sensors for doing measurements for various purposes, interfaces for additional types of communication such as wired communications etc. The inclusion and type of components of auxiliary equipment 834 may vary depending on the embodiment and/or scenario.

Power source 836 may, in some embodiments, be in the form of a battery or battery pack. Other types of power sources, such as an external power source (e.g., an electricity outlet), photovoltaic devices, or power cells may also be used. WD 810 may further comprise power circuitry 837 for delivering power from power source 836 to the various parts of WD 810 which need power from power source 836 to carry out any functionality described or indicated herein. Power circuitry 837 may, in certain embodiments, comprise power management circuitry. Power circuitry 837 may additionally or alternatively be operable to receive power from an external power source; in which case WD 810 may be connectable to the external power source (such as an electricity outlet) via input circuitry or an interface such as an electrical power cable. Power circuitry 837 may also, in certain embodiments, be operable to deliver power from an external power source to power source 836. This may be, for example, for the charging of power source 836. Power circuitry 837 may perform any formatting, converting, or other modification to the power from power source 836 to make the power suitable for the respective components of WD 810 to which power is supplied.

Virtualization Environment in Accordance with Some Embodiments

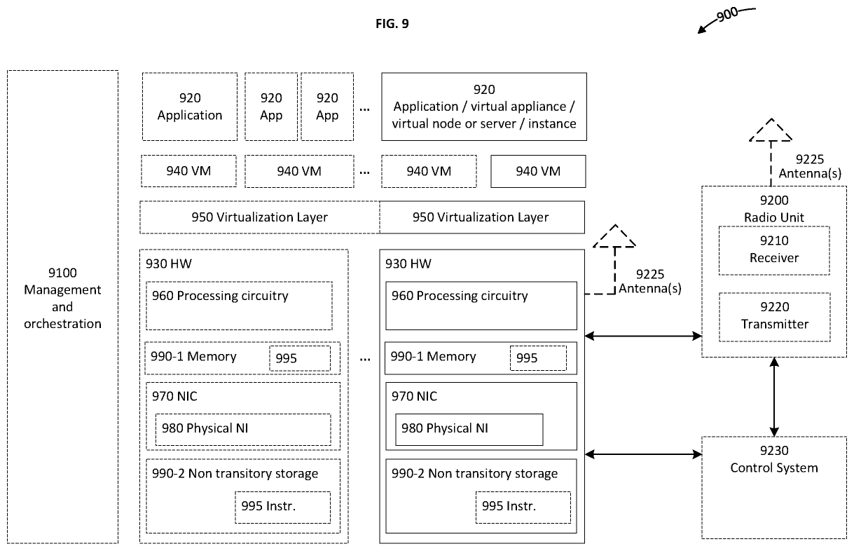

FIG. 9 is a schematic block diagram illustrating a virtualization environment 900 in which functions implemented by some embodiments may be virtualized. In the present context, virtualizing means creating virtual versions of apparatuses or devices which may include virtualizing hardware platforms, storage devices, and networking resources. As used herein, virtualization can be applied to a node (e.g., a virtualized base station or a virtualized radio access node) or to a device (e.g., a UE, a wireless device, or any other type of communication device) or components thereof and relates to an implementation in which at least a portion of the functionality is implemented as one or more virtual components (e.g., via one or more applications, components, functions, virtual machines, or containers executing on one or more physical processing nodes in one or more networks).

In some embodiments, some or all of the functions described herein may be implemented as virtual components executed by one or more virtual machines implemented in one or more virtual environments 900 hosted by one or more of hardware nodes 930. Further, in embodiments in which the virtual node is not a radio access node or does not require radio connectivity (e.g., a core network node), then the network node may be entirely virtualized.

The functions may be implemented by one or more applications 920 (which may alternatively be called software instances, virtual appliances, network functions, virtual nodes, virtual network functions, etc.) operative to implement some of the features, functions, and/or benefits of some of the embodiments disclosed herein. Applications 920 are run in virtualization environment 900 which provides hardware 930 comprising processing circuitry 960 and memory 990. Memory 990 contains instructions 995 executable by processing circuitry 960 whereby application 920 is operative to provide one or more of the features, benefits, and/or functions disclosed herein.

Virtualization environment 900, comprises general-purpose or special-purpose network hardware devices 930 comprising a set of one or more processors or processing circuitry 960, which may be commercial off-the-shelf (COTS) processors, dedicated Application Specific Integrated Circuits (ASICs), or any other type of processing circuitry including digital or analog hardware components or special purpose processors. Each hardware device may comprise memory 990-1 which may be non-persistent memory for temporarily storing instructions 995 or software executed by processing circuitry 960. Each hardware device may comprise one or more network interface controllers (NICs) 970, also known as network interface cards, which include physical network interface 980. Each hardware device may also include non-transitory, persistent, machine-readable storage media 990-2 having stored therein software 995 and/or instructions executable by processing circuitry 960. Software 995 may include any type of software including software for instantiating one or more virtualization layers 950 (also referred to as hypervisors), software to execute virtual machines 940 as well as software allowing it to execute functions, features, and/or benefits described in relation with some embodiments described herein.

Virtual machines 940 comprise virtual processing, virtual memory, virtual networking, or interface and virtual storage, and may be run by a corresponding virtualization layer 950 or hypervisor. Different embodiments of the instance of virtual appliance 920 may be implemented on one or more of virtual machines 940, and the implementations may be made in different ways.

During operation, processing circuitry 960 executes software 995 to instantiate the hypervisor or virtualization layer 950, which may sometimes be referred to as a virtual machine monitor (VMM). Virtualization layer 950 may present a virtual operating platform that appears like networking hardware to virtual machine 940.

As shown in FIG. 9, hardware 930 may be a standalone network node with generic or specific components. Hardware 930 may comprise antenna 10225 and may implement some functions via virtualization. Alternatively, hardware 930 may be part of a larger cluster of hardware (e.g., such as in a data center or customer premise equipment (CPE)) where many hardware nodes work together and are managed via management and orchestration (MANO) 9100, which, among others, oversees lifecycle management of applications 920.

Virtualization of the hardware is in some contexts referred to as network function virtualization (NFV). NFV may be used to consolidate many network equipment types onto industry standard high-volume server hardware, physical switches, and physical storage, which can be located in data centers and customer premise equipment.

In the context of NFV, virtual machine 940 may be a software implementation of a physical machine that runs programs as if they were executing on a physical, non-virtualized machine. Each of virtual machines 940, and that part of hardware 930 that executes that virtual machine, be it hardware dedicated to that virtual machine and/or hardware shared by that virtual machine with others of the virtual machines 940, forms a separate virtual network elements (VNE).

Still in the context of NFV, Virtual Network Function (VNF) is responsible for handling specific network functions that run in one or more virtual machines 940 on top of hardware networking infrastructure 930 and corresponds to application 920 in FIG. 9.

In some embodiments, one or more radio units 9200 that each include one or more transmitters 9220 and one or more receivers 9210 may be coupled to one or more antennas 9225. Radio units 9200 may communicate directly with hardware nodes 930 via one or more appropriate network interfaces and may be used in combination with the virtual components to provide a virtual node with radio capabilities, such as a radio access node or a base station.

In some embodiments, some signaling can be affected with the use of control system 8230 which may alternatively be used for communication between the hardware nodes 930 and radio units 9200.

Telecommunication Network Connected Via an Intermediate Network to a Host Computer in Accordance with Some Embodiments

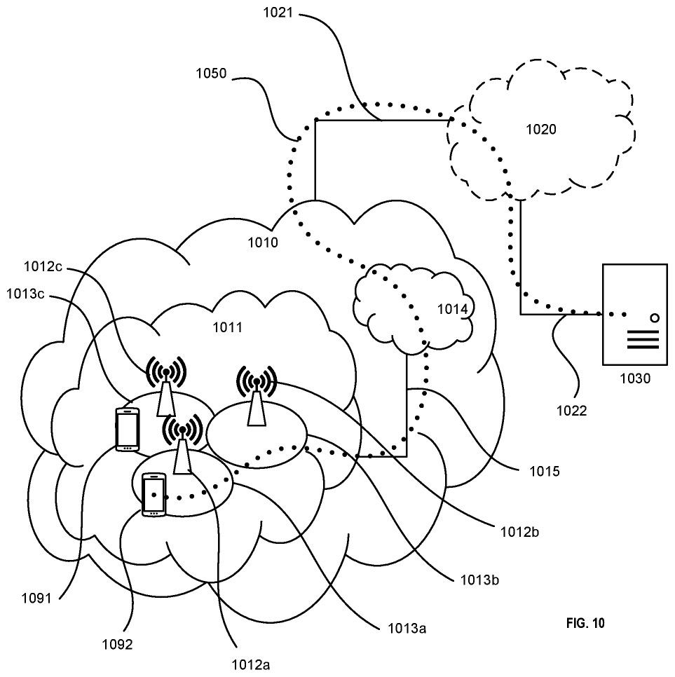

With reference to FIG. 10, in accordance with an embodiment, a communication system includes telecommunication network 1010, such as a 3GPP-type cellular network, which comprises access network 1011, such as a radio access network and core network 1014. Access network 1011 comprises a plurality of base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to core network 1014 over a wired or wireless connection 1015. A first UE 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012.

Telecommunication network 1010 is itself connected to host computer 1030, which may be embodied in the hardware and/or software of a standalone server, a cloud-implemented server, a distributed server, or as processing resources in a server farm. Host computer 1030 may be under the ownership or control of a service provider or may be operated by the service provider or on behalf of the service provider. Connections 1021 and 1022 between telecommunication network 1010 and host computer 1030 may extend directly from core network 1014 to host computer 1030 or may go via an optional intermediate network 1020. Intermediate network 1020 may be one of, or a combination of more than one of, a public, private, or hosted network; intermediate network 1020, if any, may be a backbone network or the Internet; in particular, intermediate network 1020 may comprise two or more sub-networks (not shown).

The communication system of FIG. 10 as a whole enables connectivity between the connected UEs 1091, 1092 and host computer 1030. The connectivity may be described as an over-the-top (OTT) connection 1050. Host computer 1030 and the connected UEs 1091, 1092 are configured to communicate data and/or signaling via OTT connection 1050 using access network 1011, core network 1014, any intermediate network 1020 and possible further infrastructure (not shown) as intermediaries. OTT connection 1050 may be transparent in the sense that the participating communication devices through which OTT connection 1050 passes are unaware of routing of uplink and downlink communications. For example, base station 1012 may not or need not be informed about the past routing of an incoming downlink communication with data originating from host computer 1030 to be forwarded (e.g., handed over) to a connected UE 1091. Similarly, base station 1012 need not be aware of the future routing of an outgoing uplink communication originating from the UE 1091 towards the host computer 1030.

Some of the embodiments contemplated herein above are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A computer implemented method to predict network performance of a network, the method comprising:
training a first sub-model using a subset of a plurality of time series of data values based on a set of periodicities of the time series of data values, each of the time series comprising a series of data values indexed in day order and corresponding to a performance indicator of the network, wherein the first sub-model comprises a type of generalized additive model, and wherein training the first sub-model comprises determining parameters within a plurality of univariate functions of the first sub-model;
training a second sub-model using the subset of the time series of data values, wherein the second sub-model comprises a type of autoregressive integrated moving average (ARIMA) model;
determining a weight distribution between the first sub-model and second sub-model using additional data values from the time series of data values to generate a hybrid model incorporating the first and second sub-models; and
predicting a data value of the performance indicator of the network at a later day using the hybrid model.

2. The method of claim 1, further comprising:
determining the set of periodicities of the time series of data values, wherein the determination comprises performing a Fast Fourier Transform (FFT) on the time series of data values.

3. The method of claim 1, further comprising:
identifying missing data values in the subset of the plurality of time series of data values; and
applying linear interpolation to add in one or more missing data values into the subset of the plurality of time series of data values prior to training the first and second sub-models.

4. The method of claim 1, further comprising:
identifying and removing data values that deviate from expected values for a time series of data values over a threshold prior to training the first and second sub-models.

5. The method of claim 1, wherein training the first sub-model comprises determining parameters for a first function indicating a trend of the subset of the time series of data values, a second function indicating seasonality of the subset of the time series of data values, and a third function indicating effects of holidays and events, and wherein the parameters are determined based on reducing modeling error and complexity penalty.

6. The method of claim 1, wherein training the second sub-model comprises normalizing the subset of the time series of data values.

7. The method of claim 6, wherein normalizing the subset of the time series of data values uses a Box-Cox transformation.

8. The method of claim 1, wherein training the second sub-model comprises using an Akaike information criterion to determine parameter values of the ARIMA model.

9. The method of claim 1, wherein the second sub-model comprises a Trigonometric Box-Cox transform, ARMA errors, Trend, and Seasonal components (TBATS) model.

10. The method of claim 1, wherein the performance indicator is one of the following: a call drop rate, a network throughput, a traffic latency, a packet loss rate, a retransmission rate, a reference signal received power (RSRP) level measured by a wireless device in the network, a number of connected wireless devices to a network node, a total number of calls during a period at the network node, and network uptime measured at the network node.

11. An electronic device to predict network performance of a network, the electronic device comprising:
a processor and non-transitory machine-readable storage medium that provides instructions that, when executed by the processor, cause the electronic device to perform:
training a first sub-model using a subset of a plurality of time series of data values based on a set of periodicities of the time series of data values, each of the time series comprising a series of data values indexed in day order and corresponding to a performance indicator of the network, wherein the first sub-model comprises a type of generalized additive model, and wherein training the first sub-model comprises determining parameters within a plurality of univariate functions of the first sub-model;
training a second sub-model using the subset of the time series of data values, wherein the second sub-model comprises a type of autoregressive integrated moving average (ARIMA) model;
determining a weight distribution between the first sub-model and second sub-model using additional data values from the time series of data values to generate a hybrid model incorporating the first and second sub-models; and
predicting a data value of the performance indicator of the network at a later day using the hybrid model.

12. The electronic device of claim 11, wherein the machine-readable storage medium provides instructions that, when executed by the processor, cause the electronic device to further perform:
determining the set of periodicities of the time series of data values, wherein the determination comprises performing a Fast Fourier Transform (FFT) on the time series of data values.

13. The electronic device of claim 11, wherein training the first sub-model comprises determining parameters for a first function indicating a trend of the subset of the time series of data values, a second function indicating seasonality of the subset of the time series of data values, and a third function indicating effects of holidays and events, and wherein the parameters are determined based on reducing modeling error and complexity penalty.

14. The electronic device of claim 11, wherein training the second sub-model comprises using an Akaike Information Criterion to determine parameter values of the ARIMA model.

15. The electronic device of claim 11, wherein the performance indicator is one of the following: a call drop rate, a network throughput, a traffic latency, a packet loss rate, a retransmission rate, a reference signal received power (RSRP) level measured by a wireless device in the network, a number of connected wireless devices to a network node, a total number of calls during a period at the network node, and network uptime measured at the network node.

16. A non-transitory machine-readable storage medium that provides instructions that, when executed by a processor of an electronic device, cause the electronic device to perform:
training a first sub-model using a subset of a plurality of time series of data values based on a set of periodicities of the time series of data values, each of the time series comprising a series of data values indexed in day order and corresponding to a performance indicator of a network, wherein the first sub-model comprises a type of generalized additive model, and wherein training the first sub-model comprises determining parameters within a plurality of univariate functions of the first sub-model;
training a second sub-model using the subset of the time series of data values, wherein the second sub-model comprises a type of autoregressive integrated moving average (ARIMA) model;
determining a weight distribution between the first sub-model and second sub-model using additional data values from the time series of data values to generate a hybrid model incorporating the first and second sub-models; and
predicting a data value of the performance indicator of the network at a later day using the hybrid model.

17. The non-transitory machine-readable storage medium of claim 16, wherein the machine-readable storage medium provides instructions that, when executed by the processor, cause the electronic device to further perform:
determining the set of periodicities of the time series of data values, wherein the determination comprises performing a Fast Fourier Transform (FFT) on the time series of data values.

18. The non-transitory machine-readable storage medium of claim 16, wherein the machine-readable storage medium provides instructions that, when executed by the processor, cause the electronic device to further perform:
identifying missing data values in the subset of the plurality of time series of data values; and
applying linear interpolation to add in one or more missing data values into the subset of the plurality of time series of data values prior to training the first and second sub-models.

19. The non-transitory machine-readable storage medium of claim 16, wherein training the first sub-model comprises determining parameters for a first function indicating a trend of the subset of the time series of data values, a second function indicating seasonality of the subset of the time series of data values, and a third function indicating effects of holidays and events, and wherein the parameters are determined based on reducing modeling error and complexity penalty.

20. The non-transitory machine-readable storage medium of claim 16, wherein the performance indicator is one of the following: a call drop rate, a network throughput, a traffic latency, a packet loss rate, a retransmission rate, a reference signal received power (RSRP) level measured by a wireless device in the network, a number of connected wireless devices to a network node, a total number of calls during a period at the network node, and network uptime measured at the network node.
